(19) United States
(12) Patent Application Publication
(10) Pub. No.: US 2010/0146639 A1
(43) Pub. Date: Jun. 10, 2010

(54) ONLINE DIRECTORY WITH CONTACT INFORMATION

(76) Inventors: Pete WJ Kim, Columbia, MO (US); Jennifer L. Brooks, Columbia, MO (US)

Correspondence Address: Pete Kim, 105 Miramar Ln, Columbia, MO, 65203, US

(21) Appl. No.: 12/631,857

(22) Filed: Dec. 6, 2009

Related U.S. Application Data
(60) Provisional application No. 61/120,454, filed on Dec. 6, 2008.

(51) Int. Cl. H04L 9/00; G06F 3/00

(52) U.S. Cl. 726/28; 715/738

(57) ABSTRACT

A method and system of storing and sharing contact information on a website of a specified group of users designated by a user X comprises: accessing the website by the user X; requesting the user X to provide or verify accuracy of most current contact information as a precondition to proceeding; storing the most current contact information from the user X and each user of the specified group of users; providing shared online access to contact information of user X to all users of the group; updating contact information of user X each time the website is accessed by User X; and updating contact information of each user of the group when contact information of a user of the group changes.

### REFERENCE TO RELATED APPLICATIONS

This patent application claims the benefit of U.S. Provisional Application No. 61/120,454 filed on Dec. 6, 2008, the disclosure of which is incorporated herein by reference in its entirety.

### BACKGROUND OF THE INVENTION

1. Field of the Invention

The present invention relates generally to a directory that has address book and contact information features, and which automatically updates addresses and contact information within a specified group, and that is performed online as part of a function of a website.

2. Description of Related Art

Online websites and business directories are well known. Such websites permit searches by business name, location, telephone number, and types of goods.

However, it is a problem in the art to provide a directory that has address book and contact information features, and which automatically updates addresses and contact information within a specified group, and that is performed online as part of a function of a website.

### SUMMARY OF THE INVENTION

In an embodiment there is disclosed a method of storing and sharing contact information on a website of a specified group of users designated by a user X comprises:

accesses the website by the user X;

requesting the user X to provide or verify accuracy of most current contact information as a precondition to proceeding;

storing the most current contact information from the user X and each user of the specified group of users;

providing shared online access to contact information of user X to all users of the group;

updating contact information of user X each time the website is accessed by user X; and

updating contact information of each user of the group when contact information of a user of the group changes.

In another embodiment there is disclosed a system of storing and sharing contact information on a website of a specified group of users designated by a user X comprises:

accesses the website by the user X;

requesting the user X to provide or verify accuracy of most current contact information as a precondition to proceeding;

storing the most current contact information from the user X and each user of the specified group of users;

providing shared online access to contact information of user X to all users of the group;

updating contact information of user X each time the website is accessed by user X; and

updating contact information of each user of the group when contact information of a user of the group changes.

The foregoing has outlined, rather broadly, the preferred feature of the present invention so that those skilled in the art may better understand the detailed description of the invention that follows. Additional features of the invention will be described hereinafter that form the subject of the claims of the invention. Those skilled in the art should appreciate that they can readily use the disclosed conception and specific embodiment as a basis for designing or modifying other structures for carrying out the same purposes of the present invention and that such other structures do not depart from the spirit and scope of the invention in its broadest form.

### BRIEF DESCRIPTION OF THE DRAWINGS

Other aspects, features, and advantages of the present invention will become more fully apparent from the following detailed description, the appended claim, and the accompanying drawings in which similar elements are given similar reference numerals.

FIG. 1 is a flowchart of the steps used in the method of the present invention;

FIG. 2 is a representative web page that can be used in the method of FIG. 1; and

FIG. 3 is a block diagram of a computer system for use with the present invention.

### DESCRIPTION OF THE PREFERRED EMBODIMENT

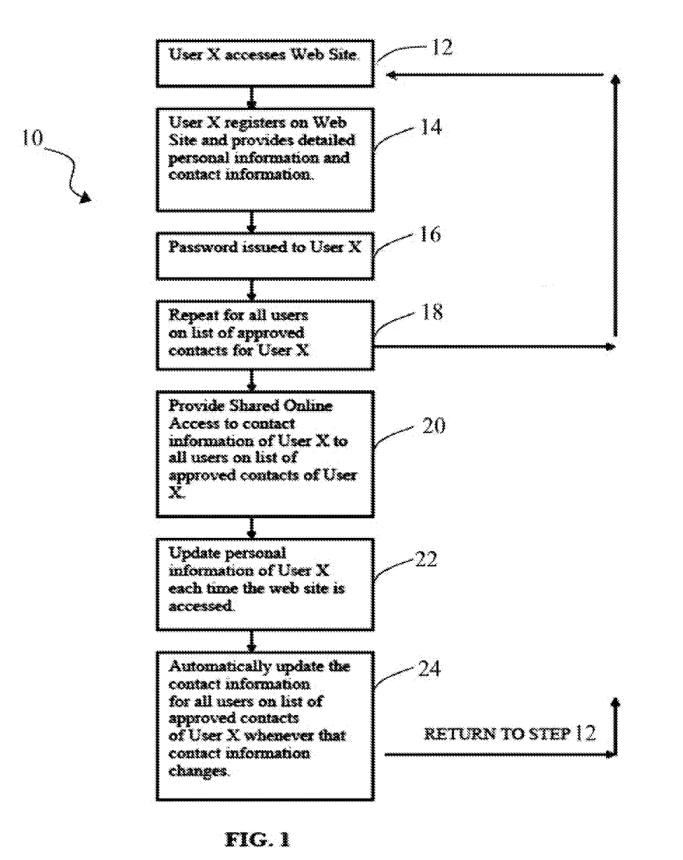

As discussed herein, and according to the present invention, a website is provided which can be accessed by a plurality of users. Users can form groups of contacts, and the contact information shared in a controlled and secure way, as follows. FIG. 1 is a flowchart 10 of a method and system of the present invention. At the start a user, herein called “User X”, accesses the website, block 12. User X registers on the website and provides detailed personal information and contact information, block 14, and a password is issued to User X, block 16.

The preceding steps are repeated for all users on a list of approved contacts for User X, block 18, and this list of approved contacts is provided by User X at block 14.

The website provides shared online access to contact information of User X to all users on the list of approved contacts of User X, block 20. The website updates personal information of User X each time the website is accessed by User X, block 22, and automatically updates the contact information for all users on the list of approved contacts, block 24, of User X whenever that contact information changes.

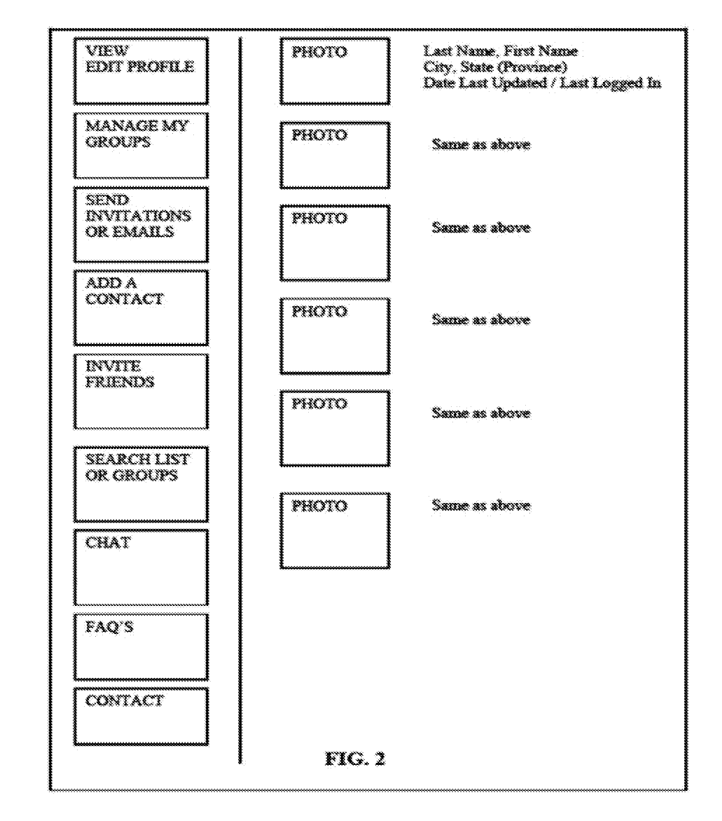

FIG. 2 is a representative web page that can be used in the method and system of FIG. 1 where the main functions of the website are as follows:

The website is a free, private, closed, social networking website that allows members to share their personal contact information with other important, close, and trusted family members, friends, business associates, or other important people in a user's life.

Each member's profile information is mandatory, helping to ensure that other members have a contact's most current and up to date contact information and also that each user has access to their contacts' most current and up to date contact information. Profile information includes name, physical address, email address, telephone number and other pertinent contact information. A user must enter the requested profile information in order to join the website. Moreover, every time a member logs into the website he or she is required to verify that the aforementioned mandatory profile information has not changed in order to use the website. If any of the mandatory profile information has changed, the member is prompted to update the information.

The website will thus enable its members to easily access and maintain the most current contact information for their friends and family, such as mailing addresses, telephone numbers, e-mail addresses, etc. The website will also alleviate the need to notify friends and family whenever contact information has changed, since a member's listed friends and family (i.e. contact list) will have access to the member's current contact information via the website. In addition, all contact information is updated and maintained from a single location, the website.

Features of the system include:

1. Private, closed, social networking website.

While other social networking sites such as MySpace, Facebook, Bebo, Friendster, Linkedln, etc. are meant for individuals to connect with not only their close friends and family, these social networking sites also promote connecting and sharing with complete strangers in all parts of the world.

Although the instant invention is a social networking website, it is designed exclusively to be used for individuals to socially connect with those people who are the closest, most important, and most trusted in their life. This ensures a much greater level of privacy for information sharing pertaining to important and private matters.

2. The website of the present invention makes it mandatory for members to enter their complete profile information.

The most unique aspect of the website is that an individual's profile information is mandatory (i.e. must be supplied) within a social networking model. In order to use the site, an individual user agrees that they will supply their most current and up to date contact information such as email addresses, telephone numbers, mailing addresses, etc. Every time a member logs onto the site they are asked to verify this information to ensure that their information is current and up to date.

Because the site is a private closed social network, individual users will understand that their information is highly secure and will only be shared with other individuals with whom they choose to network, individuals with whom they want to share their private information, and individuals who they feel should have this information. This ensures a member that the profile contact information of other members they are connected to is accurate and up to date.

While other social networking sites such as Facebook may already have the ability for members to share their profile information, it is not a mandatory function for these other social networking sites. For most of these other social networking sites much of the profile information is optional. Thus, the website of the instant invention is the first social networking site to make this information mandatory. Other social networking sites would face some major challenges to their business model if they were to make the profile information mandatory due to the fact that their social networking model is based on individuals connecting with each other even if they are complete strangers. A majority of individuals prefer that complete strangers not have their private information.

Even if an individual were connecting with their closest, most trusted friends and family on these other social networking sites, the functionality of users being able to have their friends and family's most current contact information is compromised because providing key profile information is only optional. In other words, if just one of the contacts decides not to supply contact information in their profile then a user cannot rely on the system to provide needed contact information for all of that user's contacts.

Also, since the profile information is optional, these other social networking sites do not require their members to update their profile information on a consistent basis. Therefore, even if an individual were able to have access to their friends contact information, there is no way for them to ensure the information is correct.

3. The system also allows members to export their contact list in a downloadable format. For example, the website provides its members the option of downloading the profile information of their contact(s) into a spreadsheet (e.g. MS Excel®), a document (e.g. MS Word®), or other platform. This will allow them to manipulate the profile data in various ways, such as creating and printing labels without having to re-enter this information manually to another platform.

Specific website functions include:
1) Create Account & User Log-In—Code 1
   Allows the user to create a new account, user name & password to access the website and allows the user to retrieve forgotten user name and passwords.
   Mandatory profile information verification to access accounts Allows the user to create a separate business account.
   The business account functions in the same capacity as the personal account.
   That is, only the people invited to network with a user's business will see the profile information for that user's business. (User must maintain a regular personal account in order to create a business account.)
2) View/Edit Profile—Code 2
   Allows the user to view and update their personal contact information (ability to add 2nd addresses, and any business information if they need to).
   Allows the user to upload a picture(s).
   Allows the user to designate whether they would like their name, city, & state to appear in the website search directory.
3) Manage Groups—Code 3
   Allows the user to view their contacts' personal information such as their current mailing address, telephone #'s, email addresses, other sites they belong to such as Myspace, Facebook, Snapfish, etc.
   Allows a user to create different groups such as family, friends, business associates, etc. to categorize their network contacts. (When the user creates a group only the contact name, city, & state appear in alphabetical order. When the user clicks on a name it brings up a box that shows the user the contact's information, photo(s), and also how many contacts that particular person has in their groups.)
   Gives a user the option to remove a contact from their list. (When they remove a contact from their list, they will have the option to remove their contact information from their contact's list as well. The user will also have the ability to hide themselves from a contacts list or from all contact's lists.
   Allows the user the ability to display only their primary contact information to their contacts or select which of those contacts can see all of their other non-primary information as well.
   Allows the user to download their contact into a CSV file, which can be used to create labels.
   Allows the user to see who is logged on and who isn't, who is a member and who is not, and the date the last time a contact has logged into the website.
   Allows the user to add a contact manually to their groups. (A member is anyone who has joined the website. A non-member is someone who has not joined the website but was manually added to your list.)
4) Send Invitations/Emails/Messages—Code 4
   Allows the user to send notices or invitation emails to their contacts.
   Allows the user to import attachments into their notices or invitation emails.
   Allows the user to use html to create their notices or invitation emails. For all invitation emails sent, a user will have the option to add the invitation event to a contacts calendar.
   Allows the user to choose and personalize premade e-cards and e-invitations to send to their contacts.
   Allows the user to create and edit professional newsletters using the library of predesigned newsletters.
   Allows the user to create groups to categorize their contacts
   Allows the user to send messages to their groups.
5) Invite Friends—Code 5
   Allows the user to send invitations to a group of people at one time with just one click of a button. (User can add up to 25 names and email addresses and a pre-written email from the company will be sent to those email addresses inviting them to join the website or the message can be edited to personalize it.
6) Search List, Groups, or Directory—Code 6
   Allows the user to search their list or groups for a particular contact.
   Allows the user to search the entire website directory for contacts.
   Allows the user to search by last name, first & last name, company/organization, city & state, state, country, zip/postal code, email address, or unique number.
   Allows the user to run a search by email address to cross reference the database with their other email accounts like outlook, yahoo, hotmail, etc. to see who is already a member of our website so they can connect with them.
7) Directory—Code 7
   Allows the user to add their contact information to the directory so other people can search for them. The directory is to be categorized by city and state, province and country, or similar.
8) Calendar—Code 8
   Allows users to add events to their calendar.
   Allows users to add events to their contacts calendars.
   System sends update and reminder emails for birthdays, anniversaries, events.
   (There is an option to turn off email updates or choose which notices to receive.)
   Option to add events to contacts calendar.
   User will have the ability to delete any and all events from their calendar.
9) Chat—Code 9
   Allows the user to see other members that are logged on and instant message those members who are connected to them.
10) Trash Can—Code 10
   Allows the user to delete unwanted items such as messages or events and store them in a trash can to delete permanently at a later date.
11) Quick Access—Code 11
   Allows the user to add other websites they belong to along with their login and password to that particular website. For each entry they will have a quick access button they can select that will log them into that site without them having to physically go to the website and enter their login and password. The system maintains their information and they can log into the site to easily and quickly access all their other websites from one location.
12) Text Messages—Code 12
   Allows the user the option to receive updates from the website via text message to their cell phones.
13) Revenue Share—Code 13
   Allows the user the ability to share in a percentage of the net revenue of the company by referring other members.

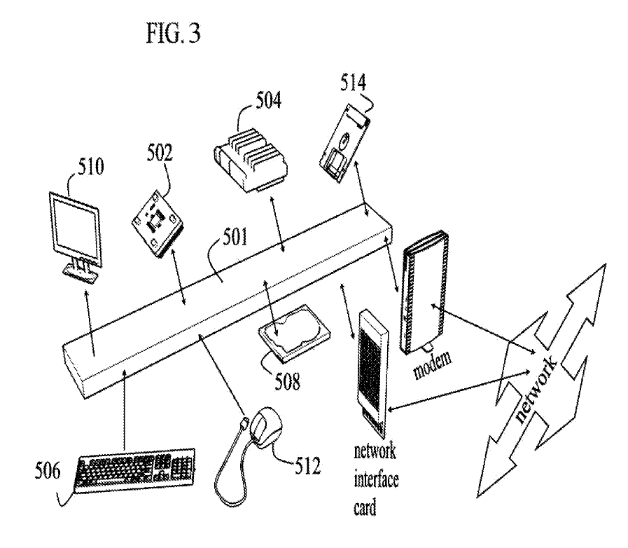

The present invention can be used on any properly configured general purpose computer system, such as the system shown in FIG. 3. Such a computer system 501 includes a processing unit (CPU) 502 connected by a bus to a random access memory 504, a storage device 508, a keyboard 506, a display 510 and a mouse 512. In addition, there is a device 514 for entry of data and software, including software embodying the present invention, into the system. An example of such a computer can be a Dell personal computer operating on the Microsoft Windows operating system, or Linux, Macintosh, etc. The invention can also be used on a laptop computer or mobile device.

The various method embodiments of the invention will be generally implemented by a computer executing a sequence of program instructions for carrying out the steps of the method, assuming all required data for processing is accessible to the computer.

The sequence of program instructions may be embodied in a computer program product comprising media storing the program instructions. As will be readily apparent to those skilled in the art, the present invention can be realized in hardware, software, or a combination of hardware and software. Any kind of computer/server system(s)—or other apparatus adapted for carrying out the methods described herein—is suited. A typical combination of hardware and software could be a general-purpose computer system with a computer program that, when loaded and executed, carries out the method, and variations on the method as described herein.

The present invention may be embodied as a system, method, or computer program product. Accordingly, the present invention may take the form of a hardware embodiment, a software embodiment, or an embodiment combining software and hardware. Furthermore, the present invention may take the form of a computer program product embodied in any tangible medium of expression having computer-usable program code embodied in the medium.

Any combination of one or more computer usable or computer readable medium(s) may be utilized. Specific examples of the computer-readable medium can include: a hard disk, a random access memory (RAM), a read-only memory (ROM), an erasable programmable read-only memory (EPROM), or Flash memory, a portable compact disc read-only memory (CD-ROM), etc. In the context of this document, a computer-usable or computer-readable medium may be any medium that can be used by or in connection with the instruction execution system or apparatus. Computer program code for carrying out operations of the present invention may be written in any combination of one or more programming languages. The program code may execute entirely on the user's computer, partly on the user's computer, as a stand-alone software package, partly on the user's computer and partly on a remote computer or entirely on the remote computer or server.

The present invention is described above with reference to a computer program products according to an embodiment of the invention. It will be understood that each block, and combinations of blocks shown, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions specified in the flowchart or blocks.

These computer program instructions may also be stored in a computer-readable medium that can direct a computer or other programmable data processing apparatus to function in a particular manner, such that the instructions stored in the computer readable medium produce an article of manufacture including instructions means which implement the function specified in the blocks.

The computer program instruction may also be loaded onto a computer or other programmable data processing apparatus to cause a series of operational steps to be performed on the computer or other programmable apparatus to produce a computer implemented process such that the instructions which execute on the computer or other programmable apparatus provide processes for implementing the functions specified.

The flowchart in the figure illustrates the architecture, functionality, and operation of possible implementations of systems, methods and computer program products according to various embodiments of the present invention. In this regard, each block in the flowchart may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact be executed substantially concurrently, or the blocks may sometimes be executed in the reverse order, depending upon the functionality involved. It will also be noted that each block of the flowchart illustration, and combinations of blocks in the flowchart illustration, can be implemented by special purpose hardware-based systems that perform the specified functions or acts, or combinations of special purpose hardware and computer instructions.

While there have been shown and described and pointed out the fundamental novel features of the invention as applied to the preferred embodiments, it will be understood that the foregoing is considered as illustrative only of the principles of the invention and not intended to be exhaustive or to limit the invention to the precise forms disclosed. Obvious modifications or variations are possible in light of the above teachings. The embodiments discussed were chosen and described to provide the best illustration of the principles of the invention and its practical application to enable one of ordinary skill in the art to utilize the invention in various embodiments and with various modifications as are suited to the particular use contemplated All such modifications and variations are within the scope of the invention as determined by the appended claims when interpreted in accordance with the breadth to which they are entitled.

What is claimed is:

1. A method of storing and sharing contact information on a website of a specified group of users designated by a user X comprises:
accesses the website by said user X;
requesting said user X to provide or verify accuracy of most current contact information as a precondition to proceeding;
storing said most current contact information from said user X and each user of said specified group of users;
providing shared online access to contact information of user X to all users of said group;
updating contact information of user X each time the website is accessed by User X; and
updating contact information of each user of said group when contact information of a user of the group changes.

2. The method of claim 1 wherein said website allows a user who has satisfied the precondition of providing or verifying accuracy of most current contact information to create a new account, user name and password to access the website and allow the user to retrieve forgotten use name and passwords.

3. The method of claim 1 wherein said website allows a user who has satisfied the precondition of providing or verifying accuracy of most current contact information to create a separate business account.

4. The method of claim 1 wherein said website allows a user who has satisfied the precondition of providing or verifying accuracy of most current contact information to view and update his/her personal contact information.

5. The method of claim 1 wherein said website allows a user who has satisfied the precondition of providing or verifying accuracy of most current contact information to designate whether he/she would like his/her name, city, and state to appear in a search directory of the website.

6. The method of claim 1 wherein said website allows a user who has satisfied the precondition of providing or verifying accuracy of most current contact information to upload a picture.

7. The method of claim 1 wherein said website allows a user who has satisfied the precondition of providing or verifying accuracy of most current contact information to view his/her contacts' personal information such as current mailing address, telephone number, email address.

8. The method of claim 1 wherein said website allows a user who has satisfied the precondition of providing or verifying accuracy of most current contact information to create different groups such as family, friends, business associates.

9. The method of claim 1 wherein said website allows a user who has satisfied the precondition of providing or verifying accuracy of most current contact information to have the option of removing a contact from his/her list.

10. The method of claim 1 wherein said website allows a user who has satisfied the precondition of providing or verifying accuracy of most current contact information to download his/her contact into a CSV file which can be used to create labels.

11. The method of claim 1 wherein said website allows a user who has satisfied the precondition of providing or verifying accuracy of most current contact information to see who is logged on and who in not logged on, who is a member and who is not a member, and the date the last time a contact has logged into the website.

12. The method of claim 1 wherein said website allows a user who has satisfied the precondition of providing or verifying accuracy of most current contact information to add a contact manually to the group.

13. The method of claim 1 wherein said website allows a user who has satisfied the precondition of providing or verifying accuracy of most current contact information to send notices or invitations emails to his/her contacts.

14. The method of claim 1 wherein said website allows a user who has satisfied the precondition of providing or verifying accuracy of most current contact information to use html to create his/her notices or invitation emails.

15. The method of claim 1 wherein said website allows a user who has satisfied the precondition of providing or verifying accuracy of most current contact information to send invitations to a group of people at one time with just one click of a button.

16. The method of claim 1 wherein said website allows a user who has satisfied the precondition of providing or verifying accuracy of most current contact information to search his/her list or group for a particular contact.

17. The method of claim 1 wherein said website allows a user who has satisfied the precondition of providing or verifying accuracy of most current contact information to add his/her contact information to the directory so others can search for him/her.

18. The method of claim 1 wherein said website allows a user who has satisfied the precondition of providing or verifying accuracy of most current contact information to add events to his/her calendar.

19. A system of storing and sharing contact information on a website of a specified group of users comprises:
accesses the website by a user X;
requesting said user X to provide or verify accuracy of most current contact information as a precondition to proceeding;
storing said most current contact information from said user X and each user of said specified group of users;
providing shared online access to contact information of user X to all users of said group;
updating contact information of user X each time the website is accessed by User X; and
updating contact information of each user of said group when contact information of a user of the group changes.

20. The system of claim 19 wherein said website allows a user who has satisfied the precondition of providing or verifying accuracy of most current contact information to create different groups such as family, friends, business associates.
